(19) United States
(12) Patent Application Publication
(10) Pub. No.: US 2026/0160976 A1
(43) Pub. Date: Jun. 11, 2026

(54) OPTICAL LENS, CAMERA MODULE AND ELECTRONIC APPARTUS

(71) Applicant: Luxvisions Innovation Technology Corp. Limited, Guangzhou City (CN)

(72) Inventors: Lingyun MI, Guangzhou City (CN); Bin QIN, Guangzhou City (CN)

(73) Assignee: Luxvisions Innovation Technology Corp. Limited, Guangzhou City (CN)

(21) Appl. No.: 19/372,953

(22) Filed: Oct. 29, 2025

(30) Foreign Application Priority Data
Dec. 9, 2024 (CN) 202411801831.9

(51) Int. Cl. G02B 13/00; G03B 13/34

(52) U.S. Cl. CPC G02B 13/0035; G02B 13/0065; G03B 13/34

(57) ABSTRACT

An optical lens, a camera module, and an electronic apparatus are provided. The optical lens includes a first lens having negative refractive power, a second lens having positive refractive power, a third lens having positive refractive power, a fourth lens having negative refractive power, a fifth lens having negative refractive power, and a sixth lens having positive refractive power. The first lens to the sixth lens having convex object-side surfaces and concave image-side surface in a paraxial region, respectively. A seventh lens and an eighth lens both have negative refractive power, and have concave object-side surfaces and convex image-side surfaces in a paraxial region, respectively; a ninth lens and a tenth lens both have positive refractive power, and have convex object-side surfaces and concave image-side surfaces in a paraxial region, respectively; an eleventh lens has refractive power.

### FIELD

The present disclosure relates to the field of optical imaging technology, and in particular to, an optical lens, a camera module and an electronic apparatus.

### BACKGROUND

With the development of optical imaging technology, people have put forward higher requirements for the shooting functions of electronic apparatuses. At present, when being engaged in the telephotograph activities, such as shooting sports, celestial bodies, wildlife and other subjects, in order to obtain high-quality photos or videos, people usually need to use professional cameras, telephoto lenses or other equipment. However, telephoto lenses have a relatively long total length, for example, 150 mm or more, and a relatively large caliber, usually the largest caliber reaching 80 mm or more. These optical lenses with a total length of 150 mm or more and a caliber of 80 mm or more and their imaging modules cannot be installed into mobile phones, tablets, drones or other electronic apparatuses.

### SUMMARY

Embodiments of the present disclosure disclose an optical lens, a camera module and an electronic apparatus, which enables compact designs of the optical lens and the camera module thereof while being able meet the requirements of telephotograph.

To achieve the above purposes, embodiments of the present disclosure disclose an optical lens including: a reflector, a first lens group, a second lens group, and a third lens group sequentially arranged along an optical axis from an object-side to an image-side, the reflector, configured to reflect incident light rays so that the incident light rays exit in a direction of the optical axis, the first lens group, including a first lens, a second lens, and a third lens sequentially arranged along the optical axis from the object-side to the image-side, the second lens group, including a fourth lens a fifth lens, a sixth lens, a seventh lens, and an eighth lens sequentially arranged along the optical axis from the object-side to the image-side, the third lens group, including a ninth lens, a tenth lens, and an eleventh lens sequentially arranged along the optical axis from the object-side to the image-side; the first lens has negative refractive power, the first lens has a convex object-side surface in a paraxial region, and the first lens has a concave image-side surface in a paraxial region; the second lens has positive refractive power, the second lens has a convex object-side surface in a paraxial region, and the second lens has a concave image-side surface in a paraxial region; the third lens has positive refractive power, the third lens has a convex object-side surface in a paraxial region, and the third lens has a concave image-side surface in a paraxial region; the fourth lens has negative refractive power, the fourth lens has a convex object-side surface in a paraxial region, and the fourth lens has a concave image-side surface in a paraxial region; the fifth lens has negative refractive power, the fifth lens has a convex object-side surface in a paraxial region, and the fifth lens has a concave image-side surface in a paraxial region; the sixth lens has positive refractive power, the sixth lens has a convex object-side surface in a paraxial region, and the sixth lens has a concave image-side surface in a paraxial region; the seventh lens has negative refractive power, the seventh lens has a concave object-side surface in a paraxial region, and the seventh lens has a convex image-side surface in a paraxial region; the eighth lens has negative refractive power, the eighth lens has a concave object-side surface in a paraxial region, and the eighth lens has a convex image-side surface in a paraxial region; the ninth lens has positive refractive power, the ninth lens has a convex object-side surface in a paraxial region, and the ninth lens has a concave image-side surface in a paraxial region; the tenth lens has positive refractive power, the tenth lens has a convex object-side surface in a paraxial region, and the tenth lens has a concave image-side surface in a paraxial region; the eleventh lens has refractive power; the optical lens satisfies the relationships: FOV<12° and/or F>200 mm, 60 mm<L<120 mm, and a maximum outer diameter of any lens from the first lens to the eleventh lens is less than 40 mm; wherein FOV is a field of view angle of the optical lens, Lis a maximum path of light rays entering the optical lens from a light inlet to an imaging surface through the reflector, the first lens group, the second lens group, and the third lens group in sequence, and F is a focal length of the optical lens.

The present disclosure further discloses an optical lens including: a reflector, a first lens group, a second lens group, and a third lens group sequentially arranged along an optical axis from an object-side to an image-side, the reflector, configured to reflect incident light rays so that the incident light rays exit in a direction of the optical axis, the first lens group, including a first lens, a second lens, and a third lens sequentially arranged along the optical axis from the object-side to the image-side, the second lens group, including a fourth lens, a fifth lens, a sixth lens, a seventh lens, and an eighth lens sequentially arranged along the optical axis from the object-side to the image-side, the third lens group, including a ninth lens, a tenth lens, an eleventh lens and a twelfth lens sequentially arranged along the optical axis from the object-side to the image-side; the first lens has negative refractive power, the first lens has a convex object-side surface in a paraxial region, and the first lens has a concave image-side surface in a paraxial region; the second lens has positive refractive power, the second lens has a convex object-side surface in a paraxial region, and the second lens has a concave image-side surface in a paraxial region; the third lens has positive refractive power, the third lens has a convex object-side surface in a paraxial region, and the third lens has a concave image-side surface in a paraxial region; the fourth lens has negative refractive power, the fourth lens has a convex object-side surface in a paraxial region, and the fourth lens has a concave image-side surface in a paraxial region; the fifth lens has negative refractive power, the fifth lens has a convex object-side surface in a paraxial region, and the fifth lens has a concave image-side surface in a paraxial region; the sixth lens has positive refractive power, the sixth lens has a convex object-side surface in a paraxial region, and the sixth lens has a concave image-side surface in a paraxial region; the seventh lens has negative refractive power, the seventh lens has a concave object-side surface in a paraxial region, and the seventh lens has a convex image-side surface in a paraxial region; the eighth lens has negative refractive power, the eighth lens has a concave object-side surface in a paraxial region, and the eighth lens has a convex image-side surface in a paraxial region; the ninth lens has positive refractive power, the ninth lens has a convex object-side surface in a paraxial region, and the ninth lens has a concave image-side surface in a paraxial region; the tenth lens has positive refractive power, the tenth lens has a convex object-side surface in a paraxial region, and the tenth lens has a concave image-side surface in a paraxial region; the eleventh lens has refractive power; the twelfth lens has negative refractive power, the twelfth lens has a concave object-side surface in a paraxial region, and the twelfth lens has a convex image-side surface in a paraxial region; the optical lens satisfies the relationships: FOV<12° and/or F>200 mm, 60 mm<L<120 mm, and a maximum outer diameter of any lens from the first lens to the twelfth lens is less than 40 mm; wherein FOV is a field of view angle of the optical lens, L is a maximum path of light rays entering the optical lens from a light inlet to an imaging surface through the reflector, the first lens group, the second lens group, and the third lens group in sequence, and F is a focal length of the optical lens.

As an optional implementation method, in an embodiment of the first aspect of the present disclosure, the optical lens satisfies the relationships: FOV≤8° 15′, and/or F≥300 mm; wherein FOV is a field of view angle of the optical lens, and F is a focal length of the optical lens.

As an optional implementation method, in an embodiment of the first aspect of the present disclosure, the optical lens satisfies the relationship: FNO>5.6, wherein FNO is an aperture number of the optical lens.

As an optional implementation method, in an embodiment of the first aspect of the present disclosure, the eleventh lens has negative refractive power, the eleventh lens has a concave object-side surface in a paraxial region, and the eleventh lens has a convex image-side surface in a paraxial region; or the eleventh lens has positive refractive power, the eleventh lens has a convex object-side surface in a paraxial region, and the eleventh lens has a concave image-side surface in a paraxial region.

As an optional implementation method, in an embodiment of the first aspect of the present disclosure, at least one of the first lens group, the second lens group, and the third lens group is movable along the optical axis.

In the second aspect, the present disclosure discloses a camera module including a housing, an image sensor, and an optical lens as described above in the first aspect, the image sensor and the optical lens are both provided in the housing, and the image sensor is provided at an image-side of the optical lens.

As an optional implementation method, in an embodiment of the second aspect of the present disclosure, a length of the housing ranges from 60 mm to 180 mm; and/or a width of the housing ranges from 15 mm to 60 mm; and/or a thickness of the housing ranges from 10 mm to 20 mm; and/or a weight of the camera module is less than 150 g.

As an optional implementation method, in an embodiment of the second aspect of the present disclosure, the camera module further includes a focusing motor provided in the housing and provided corresponding to at least one of the first lens group, the second lens group, and the third lens group of the optical lens, the focusing motor is configured to drive movement of at least one of first lens group, the second lens group, and the third lens group to facilitate zooming.

In the third aspect, the present disclosure discloses an electronic apparatus including an enclosure and a camera module as described above in the second aspect, wherein the imaging module is provided in the enclosure.

Compared with the prior art, the beneficial effects of the present disclosure are as followings.

The present disclosure provides an optical lens, a camera module, and an electronic apparatus, with the optical lens including the reflector, the first lens, the second lens to the eleventh lens sequentially arranged along the optical axis from the object-side to the image-side, the reflector being configured to reflect incident light rays so that the incident light rays exit in the direction of the optical axis, and the optical lens satisfying the relationships: the FOV<12° and/or F>200 mm, 60 mm<L<120 mm and the maximum outer diameter of any lens being less than 40 mm. The optical lens of the present disclosure has a relatively small diagonal field of view angle by being provided with a plurality of lens groups and being limited on the range of the field of view angle FOV or the focal length F and the range of the maximum path of light rays entering the optical lens from the light inlet of the optical lens to the imaging surface through the reflector and a plurality of lens group in sequence, so the magnification of the optical lens is relatively large, and the distance from which can be shot is relatively long, thus meeting the requirements of telephotograph without a professional a telephoto lens, without excessively increasing the size of the optical lens. In addition, the maximum outer diameter of any lens is limited to less than 40 mm, so that the optical lens further enables the compact designs of the optical lens and the camera module thereof while facilitating telephotograph, and thus they can be installed into a mobile phone, a tablet, a drone or other electronic apparatus, facilitating shooting activities on subject such as bird photography, moon photography and the like and obtaining high-quality photos.

### BRIEF DESCRIPTION OF THE DRAWINGS

In order to more clearly illustrate the technical solutions of the embodiments of the present disclosure, the accompanying drawings need to be used in the embodiments will be briefly introduced below. Obviously, the drawings in the following description are only some embodiments of the present disclosure, and for those ordinary skilled in the art, other drawings can also be obtained from these drawings without creative efforts.

FIG. 1 illustrates a structural schematic view of an optical lens disclosed in Embodiment 1 of the present disclosure;

FIG. 2 illustrates a field curvature plot (mm) and a distortion plot (%) of the optical lens disclosed in Embodiment 1 of the present disclosure;

FIG. 3 illustrates a resolution plot of the optical lens disclosed in Embodiment 1 of the present disclosure;

FIG. 4 illustrates a lateral chromatic aberration plot of the optical lens disclosed in Embodiment 1 of the present disclosure;

FIG. 5 illustrates a structural schematic view of an optical lens disclosed in Embodiment 2 of the present disclosure;

FIG. 6 illustrates a distortion diagram (%) and a field curvature plot (mm) of the optical lens disclosed in Embodiment 2 of the present disclosure;

FIG. 7 illustrates a resolution plot of the optical lens disclosed in Embodiment 2 of the present disclosure;

FIG. 8 illustrates a lateral chromatic aberration plot of the optical lens disclosed in Embodiment 2 of the present disclosure;

FIG. 9 illustrates a structural schematic view of an optical lens disclosed in Embodiment 3 of the present disclosure;

FIG. 10 illustrates a field curvature plot (mm) and a distortion plot (%) of the optical lens disclosed in Embodiment 3 of the present disclosure;

FIG. 11 illustrates a resolution plot of the optical lens disclosed in Embodiment 3 of the present disclosure;

FIG. 12 illustrates a lateral chromatic aberration plot of the optical lens disclosed in Embodiment 3 of the present disclosure;

FIG. 13 illustrates a structural schematic view of an optical lens disclosed in Embodiment 4 of the present disclosure;

FIG. 14 illustrates a field curvature plot (mm) and a distortion plot (%) of the optical lens disclosed in Embodiment 4 of the present disclosure;

FIG. 15 illustrates a resolution plot of the optical lens disclosed in Embodiment 4 of the present disclosure;

FIG. 16 illustrates a lateral chromatic aberration plot of the optical lens disclosed in Embodiment 4 of the present disclosure;

FIG. 17 illustrates a structural schematic view of an optical lens disclosed in Embodiment 5 of the present disclosure;

FIG. 18 illustrates a field curvature plot (mm) and a distortion plot (%) of the optical lens disclosed in Embodiment 5 of the present disclosure;

FIG. 19 illustrates a resolution plot of the optical lens disclosed in Embodiment 5 of the present disclosure;

FIG. 20 illustrates a lateral chromatic aberration plot of the optical lens disclosed in Embodiment 5 of the present disclosure;

FIG. 21 illustrates a structural schematic view of a camera module disclosed in the present disclosure.

FIG. 22 illustrates a structural schematic view of an electronic apparatus disclosed in the present disclosure when configured as a mobile phone.

Description of the reference numbers:

100, optical lens; 10, reflector; 10a, light inlet; 20, first lens group; 30, second lens group; 40, third lens group; O, optical axis; 101, imaging surface; 200, camera module; 201, housing; 202, image sensor; 203, focusing motor; 300, electronic apparatus; 301, enclosure.

### DETAILED DESCRIPTION OF EMBODIMENTS

The technical solutions in the embodiments of the present disclosure will be described clearly and completely in the following in conjunction with the accompanying drawings in the embodiments of the present disclosure, and it is obvious that the described embodiments are only a part of the embodiments of the present disclosure and not all of the embodiments. Based on the embodiments in the present disclosure, all other embodiments obtained by those ordinary skilled in the art without creative work fall within the scope of protection of the present disclosure.

In the present disclosure, the orientation or positional relationship indicated by the terms “upper”, “inner”, “outer” and the like is based on the orientation or positional relationship shown in the accompanying drawings. These terms are primarily intended to better describe the present disclosure and its embodiments, and are not intended to limit indicated device, element or component to have a specific orientation, or be configured and operated in a specific orientation.

Moreover, some of the aforementioned terms may also be used to indicate other meanings other than the orientation or positional relationship, for example, the term “on” may also be used to indicate a certain dependency or connection relationship in some circumstances. To those ordinary skilled in the art, the specific meaning of these terms in the present disclosure may be understood according to the specific circumstances.

In addition, the terms “set up”, “provided with”, and “connected” are to be broadly construed. For example, it may be a fixed connection, an attachable connection, or a monolithic construction; it may be a mechanical connection or an electrical connection; it may be a direct connection or an indirect connection through an intermediate medium; or it may be an internal connection between two devices, elements or components. To those ordinary skilled in the art, the specific meaning of the aforementioned terms in the present disclosure may be understood according to the specific circumstances.

In addition, the terms “first”, “second” and the like are used primarily to distinguish different devices, elements or components (which may be of the same or different specific types and constructions), and are not intended to indicate or imply the relative importance and number of the indicated devices, elements or components. Unless otherwise indicated, “plurality” means two or more.

When performing telephotograph of objects such as athletes on the field, wildlife, moon or the like, in order to obtain high-quality photos and videos, people often use a professional single-lens reflex camera or a telephoto lens to achieve the purpose of clear telephotograph. At present, regarding to respective subject of telephotograph, cameras and special telephoto lenses are often used, with minimum diameters≥80 mm, minimum lengths≥150 mm, focal lengths of 400 mm or more, and weights of 2 kg or more, of which the use sites are limited, portability is low, in addition, the price is not low, and therefore the popularity is not high.

At present, mobile phones, tablets and other electronic apparatuses do not have telephoto modules suitable for professionally shooting of telephotograph subjects, and mobile phones with periscope modules are the most commonly used for telephotograph. However, as for respective mobile phone with the periscope module, the field of view angle is 20 degrees or more, and both the length of its outer dimensions and the total length of any one of the effective optical paths inside, are not more than 50 mm. If it is used to shoot an object that is both far away and small, for example, a bird from a distance of 10 meters, due to the relatively low optical magnification, the proportion of the imaged bird in the picture is very low, it is difficult to see clearly the details of the eyes, the feathers and the like, and the effect is not good. Although it is also possible to change the proportion of the bird in the picture through digital zoom, this will drastically increase the noise, so that the photo will still lack detailed expression and the image quality will not be significantly improved, which is the shortcoming of mobile phones, tablets, laptop computers, drones and other electronic apparatuses in telephotograph.

Based on this, the optical lens of the present disclosure has a relatively small diagonal field of view angle by being limited on the ranges of the field of view angle FOV and the maximum path of light rays entering the optical lens from the light inlet of the optical lens to the imaging surface through the reflector and a plurality of lens group in sequence, so the magnification of the optical lens is relatively large, and the distance from which can be shot is relatively long, thus meeting the requirements of telephotograph without a professional a telephoto lens, without excessively increasing the size of the optical lens. In addition, the maximum outer diameter is limited to less than 40 mm, so that the optical lens further enables the compact designs of the optical lens and camera module thereof while facilitating telephotograph, and thus they can be installed into a mobile phone, a tablet, a drone or other electronic apparatus, facilitating shooting activities on subject such as bird photography, moon photography and the like and obtaining high-quality photos.

The technical solutions of the present disclosure will be further described below in conjunction with the embodiments and the accompanying drawings.

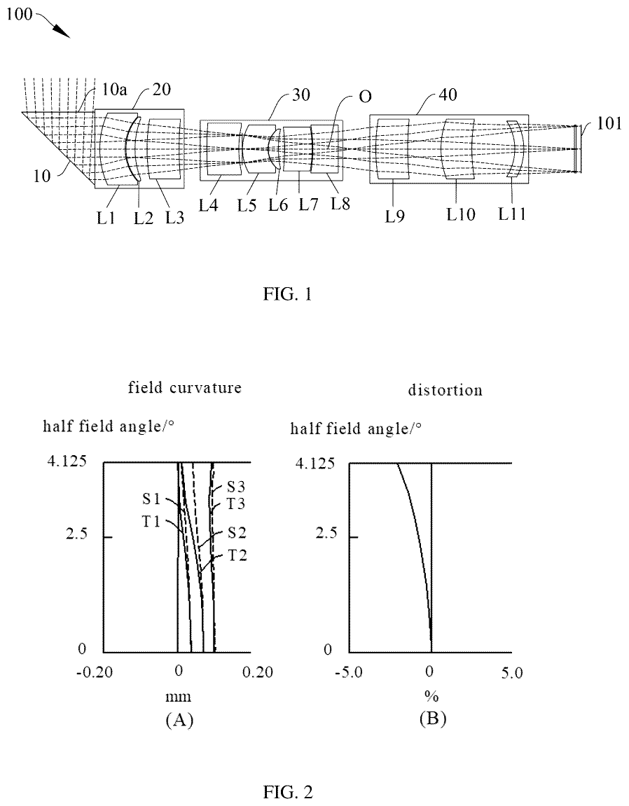

Now referring to FIG. 1, an optical lens 100 disclosed in the present disclosure includes a reflector 10, a first lens group 20, a second lens group 30, and a third lens group 40 sequentially arranged along an optical axis O from an object-side to an image-side, with the reflector 10 being configured to reflect incident light rays so that the incident light rays exit in a direction of the optical axis, the first lens group 20 including a first lens L1, a second lens L2, and a third lens L3 sequentially arranged along the optical axis O from the object-side to the image-side, the second lens group 30 including a fourth lens L4, a fifth lens L5, a sixth lens L6, a seventh lens L7, and an eighth lens L8 sequentially arranged along the optical axis O from the object-side to the image-side, and the third lens group 40 including a ninth lens L9, a tenth lens L10, and an eleventh lens L11 sequentially arranged along the optical axis O from the object-side to the image-side. When imaging, light rays enter from the light inlet 10a, enter the first lens L1, the second lens L2, the third lens L3, the fourth lens L4, the fifth lens L5, the sixth lens L6, the seventh lens L7, the eighth lens L8, the ninth lens L9, the tenth lens L10, and the eleventh lens L11 after being reflected by the reflector 10, and finally image on the imaging surface 101 of the optical lens 100.

Wherein the first lens L1 has negative refractive power, the second lens L2 has positive refractive power, the third lens L3 has positive refractive power, the fourth lens L4 has negative refractive power, the fifth lens L5 has negative refractive power, the sixth lens L6 has positive refractive power, the seventh lens L7 has negative refractive power, the eighth lens L8 has negative refractive power, the ninth lens L9 has positive refractive power, the tenth lens L10 has positive refractive power, and the eleventh lens L11 has positive refractive power or negative refractive power.

Further, the first lens L1 has a convex object-side surface in a paraxial region, and the first lens L1 has a concave image-side surface in a paraxial region; the second lens L2 has a convex object-side surface in a paraxial region, and the second lens L2 has a concave image-side surface in a paraxial region; the third lens L3 has a convex object-side surface in a paraxial region, and the third lens L3 has a concave image-side surface in a paraxial region; the fourth lens L4 has a convex object-side surface in a paraxial region, and the fourth lens L4 has a concave image-side surface in a paraxial region; the fifth lens L5 has a convex object-side surface in a paraxial region, and the fifth lens L5 has a concave image-side surface in a paraxial region; the sixth lens L6 has a convex object-side surface in a paraxial region, and the sixth lens L6 has a concave image-side surface in a paraxial region; the seventh lens L7 has a concave object-side surface in a paraxial region, and the seventh lens L7 has a convex image-side surface in a paraxial region; the eighth lens L8 has a concave object-side surface in a paraxial region, and the eighth lens L8 has a convex image-side surface in a paraxial region; the ninth lens L9 has a convex object-side surface in a paraxial region, and the ninth lens L9 has a concave image-side surface in a paraxial region; the tenth lens L10 has a convex object-side surface in a paraxial region, and the tenth lens L10 has a concave image-side surface in a paraxial region; the eleventh lens L11 has a convex object-side surface or a concave object-side surface in a paraxial region, and the eleventh lens L11 has a convex image-side surface or a concave image-side surface in a paraxial region.

Optionally, the third lens group 40 may also include a twelfth lens L12, the twelfth lens L12 has negative refractive power, the twelfth lens L12 has a concave object-side surface in a paraxial region, and the twelfth lens L12 has a convex image-side surface in a paraxial region.

It is understood that the third lens group 40 may include the twelfth lens L12 or may not include the twelfth lens L12, depending on practical demand.

In an embodiment of the present disclosure, the propagation direction of the light rays can be changed by the reflector 10, and the direction of the optical axis of the optical lens 100 can be made different from the direction in which the external light rays enter the optical lens 100, so that the periscopic structure layout of the optical lens 100 can be achieved, and thus the placement location and angle of the optical lens 100 are both made more flexible, for example, when the optical lens 100 is applied to the electronic apparatus 300, the direction of the optical axis of the optical lens 100 may be made parallel to the display screen of the electronic apparatus 300, and therefore the dimensional requirement of the accommodation space in thickness direction of the electronic apparatus 300 can be reduced.

Optionally, the reflector 10 is configured to deflect the light rays, and thus the placement location and angle of the optical lens 100 are both made more flexible. The reflector 10 may be a right-angle prism or a mirror, and the periscopic structure layout can be can be achieved by turning of the optical path.

Optionally, all of the lenses in the optical lens 100 may be made of glass, or all may be made of plastic, or some of the lenses are made of glass and some of the lenses are made of plastic.

Optionally, all of the lenses in the optical lens 100 may be aspherical lenses, or all may be spherical lenses, or some of the lenses are spherical lenses and some of the lenses are aspherical lenses. Exemplarily, the first lens L1, the second lens L2, and the third lens L3 may be spherical lenses, and the other lenses may be aspherical lenses, and using a combination of spherical lenses and aspherical lenses, the higher-order aberration may be improved, and thus the imaging quality of the optical lens 100 is improved.

In some embodiments, the optical lens 100 also includes a filter (not shown), and the filter may be provided between the image-side surface of the eleventh lens L11 or the twelfth lens L12 and the imaging surface 101 of the optical lens 100. Of course, in other embodiments, the filter may also be provided between other lenses, and the setting is adjusted according to the actual situation, which will not be specified in the present embodiment. In the present embodiment, an infrared cut filter may be selected as the filter, and thus other wavelengths of light such as infrared light can be filtered out, and only visible light is allowed to pass through, so that the imaging is more consistent with the visual experience of the human eye. Of course, an infrared bandpass filter may selected as the filter, and thus other wavelengths of light such as visible light can be filtered out and only infrared light is allowed to pass through, so that the imaging quality is improved by other wavelengths of light such as visible light being filtered out; and the optical lens 100 may be used as an infrared optics lens 100, that is, the optical lens 100 is capable of imaging and obtaining a relatively good imaging effect even in dim environments and in other special application scenarios. Preferably, the filter may be made of glass, and of course, in other embodiments, the filter may also be made by coating on optical glass, or may be a filter made of other materials, which may be selected according to the actual needs, and will not be specified in the present embodiment.

In some embodiments, the optical lens 100 also includes a protective glass, and the protective glass is provided between the filter and the imaging surface 101, thereby enabling proximity to the image sensor 202 during subsequent assembly, and thus playing a protective role.

In an implementation method, the optical lens 100 satisfies the relation FOV<12°, FOV being the field of view angle of the optical lens 100. By controlling the FOV within a smaller range, the optical magnification of the optical lens 100 can be made larger, so that the details of the shot image are clearer and the effect is better, while the distance from which can be shot is longer.

Optionally, the optical lens 100 satisfies the relation FOV≤8° 15′, FOV being the field of view angle of the optical lens 100. When the FOV is 8°15′, corresponding to an single-lens reflex camera or a mirrorless camera, it is equivalent to a telephoto lens with a focal length of 300 mm, and the smaller the FOV, the longer the focal length corresponding to the single-lens reflex camera or the mirrorless camera, and the better the imaging quality presented. By satisfying the relation, the optical lens 100 is made to have better imaging quality when performing telephotograph.

Further, the optical lens 100 satisfies the relation 3°≤FOV≤8° 15′, FOV being the field of view angle of the optical lens 100. By further setting the field of view angle of the optical lens 100, it is made that the optical lens 100 has a better magnification and that the imaging effect is better while the distance from which can be shot is longer.

Optionally, the FOV may be 8° 15′, 6°10′, 5°, 4°10′, 3°5′, and so on. When being applied to electronic apparatuses such mobile phones, tablets or the like, the designs of the FOVs may correspond to lenses with ultra-long focal lengths of 300 mm, 400 mm, 500 mm, 600 mm, 800 mm and so on, in a professional camera. Due to the ultra-long focal length design, a heat-free design is more necessary to cope with extreme temperature environments, for example, in the most widely used application scenario when it is a mobile phone, the heat generated inside the device often causes the temperature of the lens to reach 50 degrees or more. Therefore, in order to reduce the effect brought by the temperature, preferably, all the lenses in the optical lens optical lens 100 are made of glass, and the lenses made of glass can suppress the offset of the back focal length of the optical lens 100 caused by temperature changes, so that the stability of the optical lens optical lens 100 is improved. Meanwhile, the blur imaging of the optical lens 100 caused by changes between high temperature and low temperature in the use environment, which affects the normal use of the optical lens 100, may be avoid by using glass material. In addition, all of the lenses in the optical lens optical lens 100 in the embodiments of the present disclosure may be spherical lenses, which can make the optical lens optical lens 100 have a better high temperature resistance property.

In an implementation method, the optical lens 100 satisfies the relation F>200 mm, F being the focal length of the optical lens 100. By the range of the focal length being limited, the magnification of the optical lens 100 can be made larger, the size of the image can be larger, and the range of the field of view may be smaller, so that requirements of imaging from a longer distance is met.

Optionally, the optical lens 100 satisfies the relation F≥300 mm, F being the focal length of the optical lens 100. Further, the optical lens 100 satisfies the relation 300 mm≤F≤800 mm, for example, it may be 300 mm, 400 mm, 500 mm, 600 mm, 800 mm, and so on. In this way, it can be made that imaging of the optical lens 100 is more detailed and has better quality while the optical lens 100 images from a long distance.

In an implementation method, the optical lens 100 satisfies the relation 60 mm<L<120 mm, L being the maximum path L of light rays entering the optical lens 100 from the light inlet 10a to the imaging surface 101 through the reflector 10, the first lens group 20, the second lens group 30, and the third lens group 40 in sequence. By being limited on the range of the maximum path L of light rays entering the optical lens 100 from the light inlet 10a of the optical lens 100 to the imaging surface 101 through the reflector 10 and a plurality of lens groups in sequence, compared to the related technology in which cameras and special telephoto lenses are used and the goal of telephotograph can be achieved only when the following relationships are met: the minimum diameter≥80 mm and the minimum length is ≥150 mm, the optical lens 100 of the present disclosure enables compact designs of the optical lens 100 and the camera module 200 thereof while being able to shoot from a long distance, so that they can be installed into a mobile phone, a tablet, a drone or other electronic apparatus 300.

Optionally, the distribution of all the lenses in the optical lens 100 may be linear, or 90° bent, or 180° folded, as long as it is satisfied that the optical maximum path L therein is in the range of 60 mm to 120 mm, which will not be specified in the embodiments of the present disclosure.

In an example, as shown in FIG. 1, the distribution of all the lenses in the optical lens 100 may be linear, that is, the first lens L1 to the eleventh lens L11 are arranged in the same straight line along the direction of an optical axis.

In another example, the distribution of all the lenses in the optical lens 100 may be 90° bend, that is, the optical lens 100 may have two optical axes which are perpendicular to each other, a reflector 10 may further be provided at the intersection of the two optical axes, and lenses are provided on both optical axes. For example, the lenses in the first lens group 20 and the second lens group 30 may be arranged sequentially along the first optical axis, and the lenses in the third lens group 40 may be arranged sequentially along the second optical axis.

In still another example, the distribution of all the lenses in the optical lens 100 may also be 180° folded, that is, the optical lens 100 may have three optical axes with the first optical axis being perpendicular to the second optical axis and the third optical axis being perpendicular to the second optical axis and parallel to the first optical axis, a reflector 10 may further be provided at each intersection of two optical axes perpendicular to each other, lenses are provided on each of the three optical axes. For example, the lenses in the first lens group 20 may be arranged sequentially along the first optical axis, the lenses in the second lens group 30 may be arranged sequentially along the second optical axis, and the lenses in the third lens group 40 may be arranged sequentially along the third optical axis.

In an implementation method, the optical lens 100 satisfies that the maximum outer diameter of any lens from the first lens L1 to the eleventh lens L11 is less than 40 mm. By the maximum outer diameter of any lens being limited to less than 40 mm, the optical lens 100 enables compact designs of the optical lens 100 and the camera module 200 thereof while facilitating telephotograph.

It is understood that the light rays enter from the light inlet 10a, are totally reflected by the reflector 10, enter the first lens L1 to the third lens group 40 in sequence, change and adjust the propagation direction by means of refraction, dispersion and focusing, reach the filter, and are ultimately projected onto the image sensor 202 to form an image signal. Since a plurality of lenses are used, and the optical design of the optical lens 100 has been significantly changed by the FOV being limited to less than 10° and the range of the maximum path L of the light rays entering the optical lens 100 from the light inlet 10a of the optical lens 100 to the imaging surface 101 through the reflector 10 and a plurality of lens groups in sequence being limited, the magnification of the optical lens 100 is relatively large, which can enable the goal of ultra telephotograph from a distance of 10 meters and more, thereby meeting the requirements of telephoto without a professional a telephoto lens, without excessively increasing the size of the optical lens, so that the optical lens 100 can be installed into a mobile phone, a tablet, a drone, or other electronic apparatus 300.

If the optical lens 100 and the camera module 200 are applied to mobile phones, tablets computers, laptop computers and other products, the maximum aperture number of the optical lens 100 will not be too large due to the thickness requirement of the products themselves, and it is necessary to turn on the flash to obtain a relatively good imaging quality. Based on this, in an implementation method, the optical lens 100 satisfies the relation FNO>5.6. Wherein the FNO is the aperture number of the optical lens 100. By the aperture number of the optical lens 100 being limited to satisfy the above relationship, the relative illumination of the optical lens 100 is made higher, so that it has good imaging quality even in relatively dark environments such as at night or on cloudy or rainy days, and meets the requirements of large aperture and high resolution.

In an implementation method, at least one of the first lens group 20, the second lens group 30, and the third lens group 40 is movable along the direction of the optical axis. That is, the optical lens 100 can be a zoom lens, which enables the goals of auto-focusing and clear imaging via the moving lenses.

### Embodiment 1

FIG. 1 is a structural schematic view of the optical lens 100 disclosed in Embodiment 1 of the present disclosure. The optical lens 100 includes the reflector 10, the first lens group 20, the second lens group 30, and the third lens group 40 sequentially arranged along the optical axis O from the object-side to the image-side. The light rays enter the optical lens 100 along the optical axis O, being diverted by the reflector 10, and enter the first lens group 20 composed of the first lens L1, the second lens L2, and the third lens L3, the second lens group 30 composed of the fourth lens L4, the fifth lens L5, the sixth lens L6, the seventh lens L7, and the eighth lens L8, and the third lens group 40 composed of the ninth lens L9, the tenth lens L10, and the eleventh lens L11 in sequence, and finally reach the imaging surface 101.

In the present embodiment, the eleventh lens L11 has negative refractive power, the eleventh lens L11 has a concave object-side surface in a paraxial region, and the eleventh lens L11 has a convex image-side surface in a paraxial region. For the refractive power and surface design of other lenses, please refer to previous description, which will not be specified here.

Specifically, taking the maximum field of view angle FOV=8° 15′ in the optical lens 100 as an example, other parameters of the optical lens 100 are given in Table 1 below. Wherein the elements along the optical axis O of the optical lens 100 from the object-side to the image-side are sequentially arranged in the order of the elements from top to bottom in Table 1. The Y radius in Table 1 is the radius of curvature of the object-side surface or image-side surface of a corresponding lens at the optical axis O. In the column of parameters for “thickness” of the lens, the first value is the thickness of the lens on the optical axis O, and the second value is the distance from the image-side surface of the lens to the rear surface on the optical axis O. It is understood that the units of Y radius and thickness in Table 1 are mm.

TABLE 1
Embodiment 1
FOV = 8°15′

| | | Thick- | Refractive | Abbe | Optical |
|---|---|---|---|---|---|
| Name | Y Radius | ness | index | number | power |
| First lens L1 | 21.685 | 6.349 | 1.73 | 28.30 | Negative |
| | 12.020 | | | | |
| Second lens L2 | 12.122 | 2.251 | 1.61 | 37.00 | Positive |
| | 20.890 | | | | |
| Third lens L3 | 43.002 | 7.992 | 1.61 | 37.00 | Positive |
| | 83.499 | | | | |
| Fourth lens L4 | 100.750 | 8.001 | 1.62 | 36.40 | Negative |
| | 25.976 | | | | |
| Fifth lens L5 | 12.285 | 6.366 | 1.92 | 18.90 | Negative |
| | 6.349 | | | | |
| Sixth lens L6 | 6.449 | 2.524 | 1.62 | 36.40 | Positive |
| | 23.608 | | | | |
| Seventh lens L7 | −47.436 | 6.892 | 1.62 | 36.40 | Negative |
| | −29.982 | | | | |
| Eighth lens L8 | −35.044 | 6.299 | 1.61 | 37.00 | Negative |
| | −1385.048 | | | | |
| Ninth lens L9 | 45.621 | 7.978 | 1.62 | 36.40 | Positive |
| | 79.513 | | | | |
| Tenth lens L10 | 20.772 | 7.726 | 1.62 | 36.40 | Positive |
| | 42.350 | | | | |
| Eleventh lens L11 | −13.019 | 2.221 | 1.62 | 36.40 | Negative |
| | −14.553 | | | | |

(A) in FIG. 2 is a field curvature plot (mm) of the optical lens 100 disclosed in Embodiment 1 of the present disclosure, wherein the abscissa along the X-axis direction represents the focus offset in mm, and the ordinate along the Y-axis direction represents the half field angle in °. T1, S1 respectively represent the curvature of the imaging surface 101 of the optical lens 100 in the meridional direction and the sagittal direction, at 0.5876 μm wavelength, T2, S2 respectively represent the curvature of the imaging surface 101 of the optical lens 100 in the meridional direction and the sagittal direction at 0.4861 μm wavelength, 0.4861, and T3, S3 respectively represent the curvature of the imaging surface 101 of the optical lens 100 in the meridional direction and the sagittal direction at 0.6563 μm wavelength. As can be seen from (A) in FIG. 2, the field curvature of the optical lens 100 is relatively small, the field curvature and the astigmatism at each field of view are well corrected, and the center and the edges of the field of view all have clear imaging. (B) in FIG. 2 is a distortion plot (%) of the optical lens 100 disclosed in Embodiment 1 of the present disclosure at 0.5876 μm wavelength. Wherein the abscissa along the X-axis direction represents the aberration, and the ordinate along the Y-axis direction represents the half field angle in °. As can be seen from (B) in FIG. 2, at this wavelength, the image distortion caused by the main beam is relatively small, the optical lens 100 has an excellent anti-aberration property, and the aberration of the optical lens 100 is well corrected.

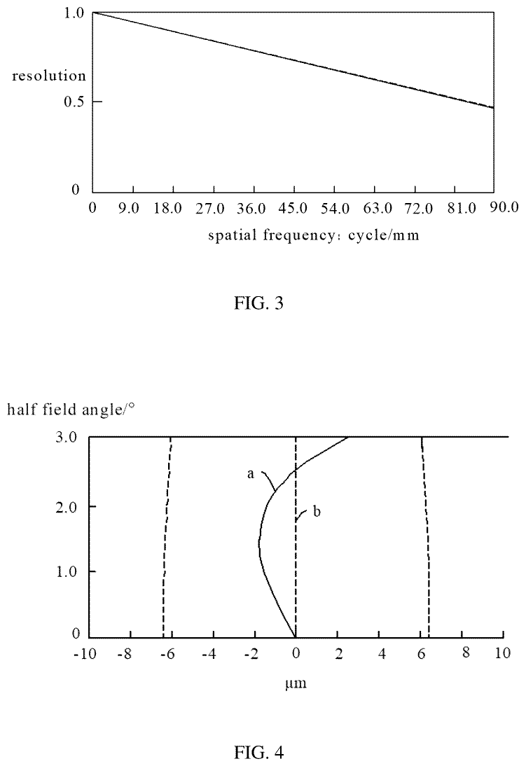

FIG. 3 is a resolution plot of the optical lens 100 disclosed in Embodiment 1 of the present disclosure. Wherein the abscissa along the X-axis direction represents the spatial frequency in cycle/mm, and the ordinate along the Y-axis direction represents the resolution. As can be seen from FIG. 3, the optical lens 100 has a better resolution, which makes the imaging of the optical lens 100 clearer.

FIG. 4 is a lateral chromatic aberration plot of the optical lens 100 disclosed in Embodiment 1 of the present disclosure. Wherein the abscissa along the X-axis direction represents the axial chromatic aberration in μm, and the ordinate along the Y-axis direction represents the half field angle in °. a represents being at 0.4861 μm wavelength, and b represents being at 0.6563 μm wavelength. As can be seen from FIG. 4, the chromatic aberration is controlled within a relatively small range, and the optical lens 100 has an excellent chromatic aberration property.

### Embodiment 2

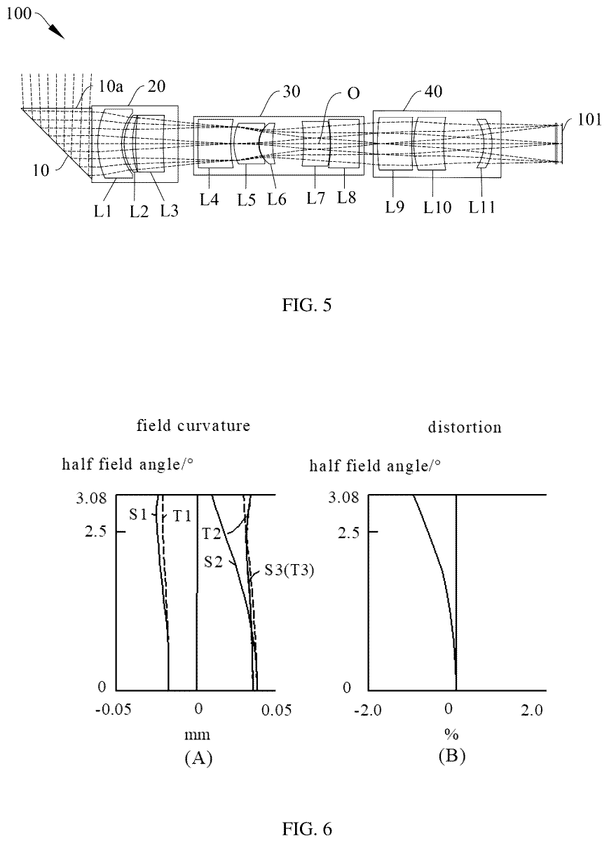

FIG. 5 is a structural schematic view of the optical lens 100 disclosed in Embodiment 2 of the present disclosure, the optical lens 100 includes the reflector 10, the first lens group 20, the second lens group 30, and the third lens group 40 sequentially arrange along the optical axis O from the object-side to the image-side. Light rays enter the optical lens 100 along the optical axis O, being diverted by the reflector 10, and enter the first lens group 20 composed of the first lens L1, the second lens L2, and the third lens L3, the second lens group 30 composed of the fourth lens L4, the fifth lens L5, the sixth lens L6, the seventh lens L7, and the eighth lens L8, and the third lens group 40 composed of the ninth lens L9, the tenth lens L10, and the eleventh lens L11 in sequence, and finally reach the imaging surface 101.

Specifically, taking the maximum field of view angle FOV=6° 10′ in the optical lens 100 as an example, other parameters of the optical lens 100 are given in Table 2 below. And the definitions of each of these parameters can be derived from the description of the foregoing embodiment, which will not be elaborated here. In addition, for the correspondence between the refractive power and the shape of each lens, please refer to the foregoing Embodiment 1, which will not be elaborated here.

TABLE 2
Embodiment 2
FOV = 6°10′

| | | Thick- | Refractive | Abbe | Optical |
|---|---|---|---|---|---|
| Name | Y Radius | ness | index | number | power |
| First lens L1 | 21.462 | 5.891 | 1.73 | 28.30 | Negative |
| | 11.873 | | | | |
| Second lens L2 | 12.086 | 2.072 | 1.61 | 37.00 | Positive |
| | 21.187 | | | | |
| Third lens L3 | 47.152 | 6.835 | 1.61 | 37.00 | Positive |
| | 92.725 | | | | |
| Fourth lens L4 | 121.763 | 8.101 | 1.62 | 36.40 | Negative |
| | 28.161 | | | | |
| Fifth lens L5 | 11.866 | 6.104 | 1.92 | 18.90 | Negative |
| | 6.161 | | | | |
| Sixth lens L6 | 6.323 | 3.277 | 1.62 | 36.40 | Positive |
| | 21.438 | | | | |
| Seventh lens L7 | −40.074 | 6.550 | 1.62 | 36.40 | Negative |
| | −27.286 | | | | |
| Eighth lens L8 | −34.946 | 7.081 | 1.61 | 37.00 | Negative |
| | −705.890 | | | | |
| Ninth lens L9 | 48.522 | 8.506 | 1.62 | 36.40 | Positive |
| | 108.014 | | | | |
| Tenth lens L10 | 20.225 | 7.354 | 1.62 | 36.40 | Positive |
| | 39.784 | | | | |
| Eleventh lens L11 | −10.881 | 1.993 | 1.62 | 36.40 | Negative |
| | −12.129 | | | | |

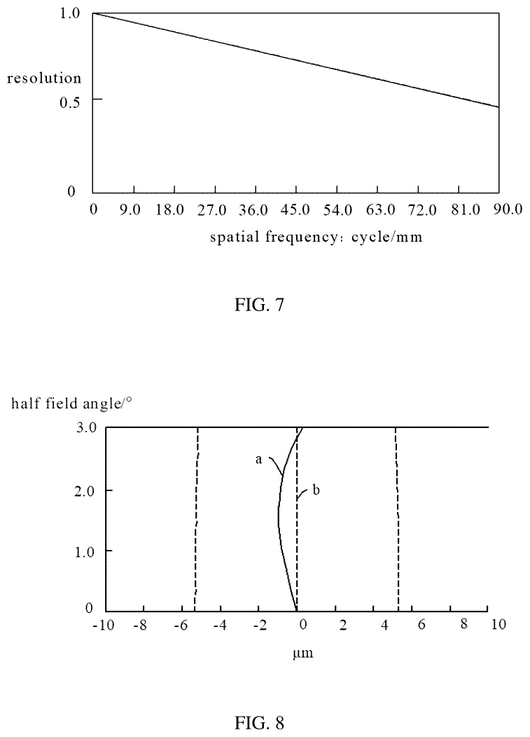

Referring to FIGS. 6 to 8, the field curvature, distortion and chromatic aberration of the optical lens optical lens 100 are well controlled and the optical lens optical lens 100 has good resolution, so that the optical lens optical lens 100 in this embodiment has a good imaging quality. With respect to the wavelengths and labels of the curves in FIGS. 6 to 8, description of FIGS. 2 to 4 in Embodiment 1 may be referred to, which will not be elaborated here.

### Embodiment 3

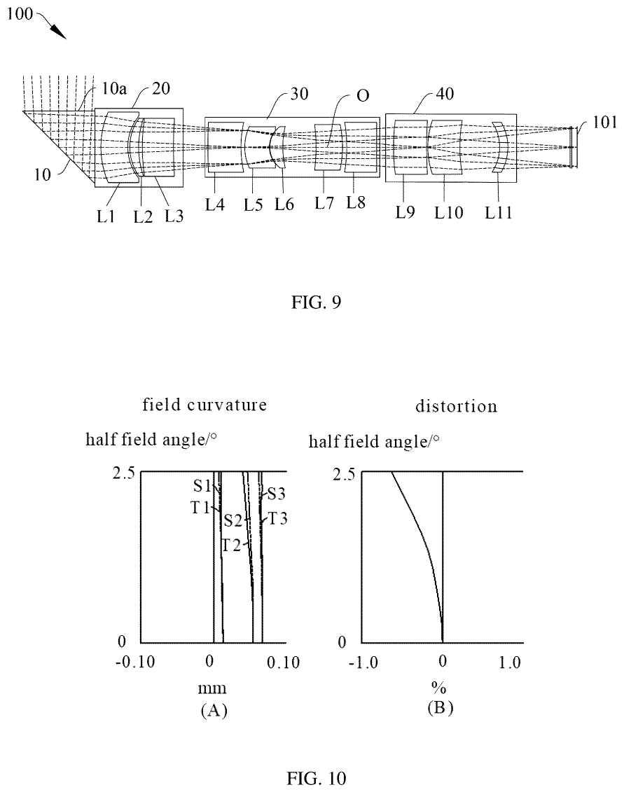

FIG. 9 is a structural schematic view of the optical lens 100 disclosed in Embodiment 3 of the present disclosure, the optical lens 100 includes the reflector 10, the first lens group 20, the second lens group 30, and the third lens group 40 sequentially arrange along the optical axis O from the object-side to the image-side. Light rays enter the optical lens 100 along the optical axis O, being diverted by the reflector 10, and enter the first lens group 20 composed of the first lens L1, the second lens L2, and the third lens L3, the second lens group 30 composed of the fourth lens L4, the fifth lens L5, the sixth lens L6, the seventh lens L7, and the eighth lens L8, and the third lens group 40 composed of the ninth lens L9, the tenth lens L10, and the eleventh lens L11 in sequence, and finally reach the imaging surface 101.

Specifically, taking the maximum field of view angle FOV−5° in the optical lens 100 as an example, other parameters of the optical lens 100 are given in Table 3 below. And the definitions of each of these parameters can be derived from the description of the foregoing embodiments, which will not be elaborated here. In addition, for the correspondence between the refractive power and the shape of each lens, please refer to the foregoing Embodiment 1, which will not be elaborated here.

TABLE 3
Embodiment 3
FOV = 5°

| | | Thick- | Refractive | Abbe | Optical |
|---|---|---|---|---|---|
| Name | Y Radius | ness | index | number | power |
| First lens L1 | 21.477 | 6.501 | 1.73 | 28.30 | Negative |
| | 11.883 | | | | |
| Second lens L2 | 12.105 | 2.127 | 1.61 | 37.00 | Positive |
| | 21.083 | | | | |
| Third lens L3 | 48.176 | 7.507 | 1.61 | 37.00 | Positive |
| | 96.647 | | | | |
| Fourth lens L4 | 136.359 | 8.000 | 1.62 | 36.40 | Negative |
| | 27.216 | | | | |
| Fifth lens L5 | 11.845 | 5.939 | 1.92 | 18.90 | Negative |
| | 6.187 | | | | |
| Sixth lens L6 | 6.325 | 3.127 | 1.62 | 36.40 | Positive |
| | 21.499 | | | | |
| Seventh lens L7 | −41.981 | 6.379 | 1.62 | 36.40 | Negative |
| | −25.697 | | | | |
| Eighth lens L8 | −35.437 | 7.209 | 1.61 | 37.00 | Negative |
| | −752.445 | | | | |
| Ninth lens L9 | 48.440 | 7.972 | 1.62 | 36.40 | Positive |
| | 101.410 | | | | |
| Tenth lens L10 | 19.843 | 7.720 | 1.62 | 36.40 | Positive |
| | 38.634 | | | | |
| Eleventh lens L11 | −10.802 | 1.999 | 1.62 | 36.40 | Negative |
| | −12.064 | | | | |

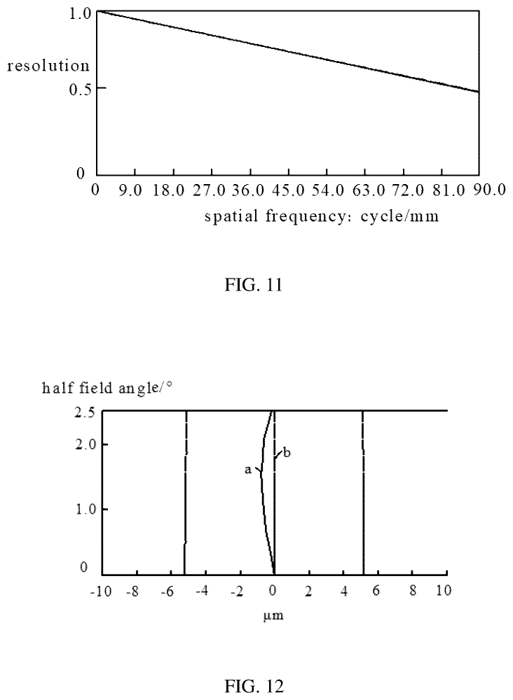

Referring to FIGS. 10 to 12, the field curvature, distortion and chromatic aberration of the optical lens optical lens 100 are well controlled and the optical lens optical lens 100 has good resolution, so that the optical lens optical lens 100 in this embodiment has a good imaging quality. With respect to the wavelengths and labels of the curves in FIGS. 10 to 12, description of FIGS. 2 to 4 in Embodiment 1 may be referred to, which will not be elaborated here.

### Embodiment 4

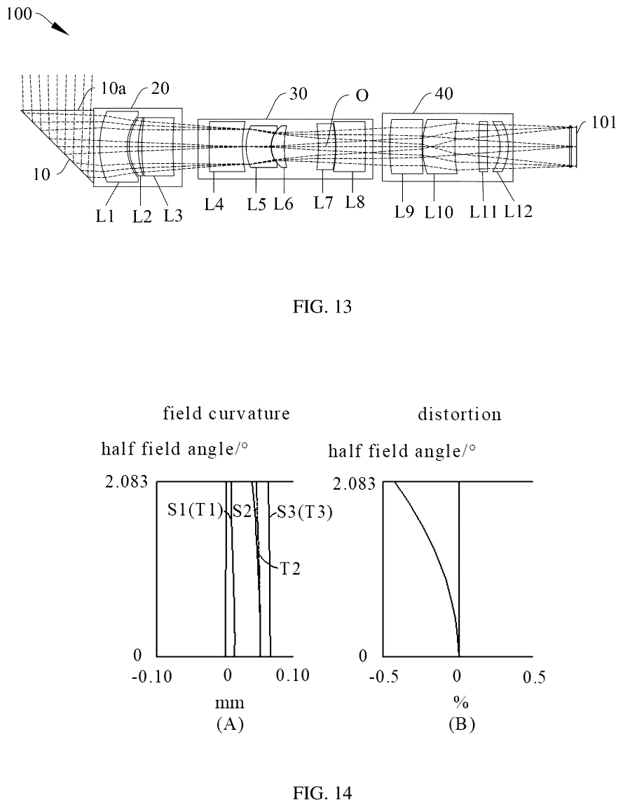

FIG. 13 is a structural schematic view of the optical lens 100 disclosed in Embodiment 4 of the present disclosure, the optical lens 100 includes the reflector 10, the first lens group 20, the second lens group 30, and the third lens group 40 sequentially arrange along the optical axis O from the object-side to the image-side. Light rays enter the optical lens 100 along the optical axis O, being diverted by the reflector 10, and enter the first lens group 20 composed of the first lens L1, the second lens L2, and the third lens L3, the second lens group 30 composed of the fourth lens L4, the fifth lens L5, the sixth lens L6, the seventh lens L7, and the eighth lens L8, and the third lens group 40 composed of the ninth lens L9, the tenth lens L10, the eleventh lens L11 and the twelfth lens L12 in sequence, and finally reach the imaging surface 101.

In the present embodiment, the eleventh lens L11 has positive refractive power, the eleventh lens L11 has a convex object-side surface in a paraxial region, and eleventh lens L11 has a concave image-side surface in a paraxial region. The twelfth lens L12 has negative refractive power, the twelfth lens L12 has a concave object-side surface in a paraxial region, and the twelfth lens L12 has a convex image-side surface in a paraxial region. With respect to the designs for refractive power and shape of other lenses, the foregoing description is referred to, which will not be elaborated here.

Specifically, taking the maximum field of view angle FOV=4°10′ in the optical lens 100 as an example, other parameters of the optical lens 100 are given in Table 4 below. And the definitions of each of these parameters can be derived from the description of the foregoing embodiments, which will not be elaborated here.

TABLE 4
Embodiment 4
FOV = 4°10′

| | | Thick- | Refractive | Abbe | Optical |
|---|---|---|---|---|---|
| Name | Y Radius | ness | index | number | power |
| First lens L1 | 21.630 | 6.559 | 1.73 | 28.30 | Negative |
| | 11.932 | | | | |
| Second lens L2 | 12.157 | 2.151 | 1.61 | 37.00 | Positive |
| | 21.194 | | | | |
| Third lens L3 | 48.021 | 7.439 | 1.61 | 37.00 | Positive |
| | 95.553 | | | | |
| Fourth lens L4 | 142.535 | 8.000 | 1.62 | 36.40 | Negative |
| | 27.412 | | | | |
| Fifth lens L5 | 11.834 | 5.961 | 1.92 | 18.90 | Negative |
| | 6.185 | | | | |
| Sixth lens L6 | 6.317 | 3.063 | 1.62 | 36.40 | Positive |
| | 21.501 | | | | |
| Seventh lens L7 | −39.668 | 4.129 | 1.62 | 36.40 | Negative |
| | −24.888 | | | | |
| Eighth lens L8 | −31.415 | 7.056 | 1.61 | 37.00 | Negative |
| | −201.693 | | | | |
| Ninth lens L9 | 47.772 | 7.744 | 1.62 | 36.40 | Positive |
| | 99.332 | | | | |
| Tenth lens L10 | 19.845 | 7.726 | 1.62 | 36.40 | Positive |
| | 38.668 | | | | |
| Eleventh lens L11 | 147.904 | 2.022 | 1.62 | 36.40 | Positive |
| | 150.023 | | | | |
| Twelfth lens L12 | −11.082 | 2.000 | 1.62 | 36.40 | Negative |
| | −12.488 | | | | |

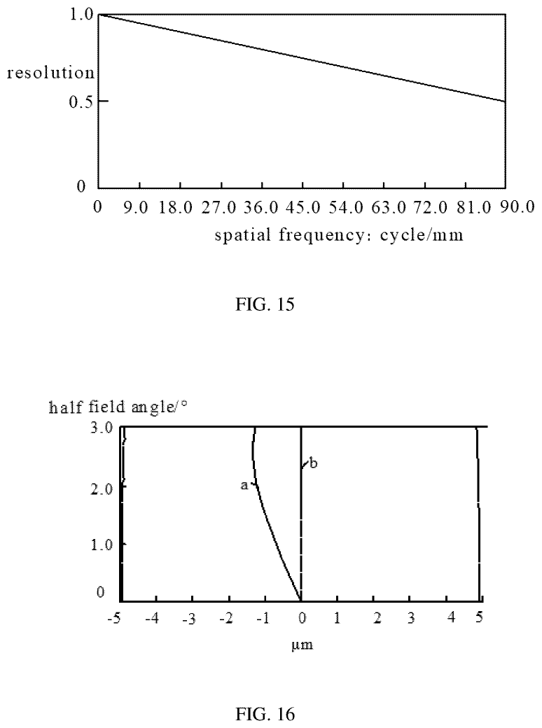

Referring to FIGS. 14 to 16, the field curvature, distortion and chromatic aberration of the optical lens optical lens 100 are well controlled and the optical lens optical lens 100 has good resolution, so that the optical lens optical lens 100 in this embodiment has a good imaging quality. With respect to the wavelengths and labels of the curves in FIGS. 14 to 16, description of FIGS. 2 to 4 in Embodiment 1 may be referred to, which will not be elaborated here.

### Embodiment 5

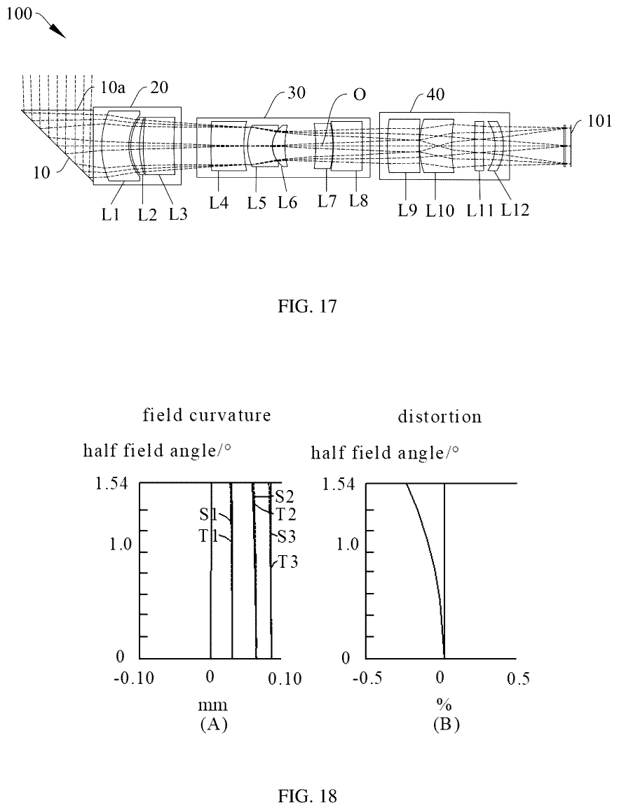

FIG. 17 is a structural schematic view of the optical lens 100 disclosed in Embodiment 5 of the present disclosure, the optical lens 100 includes the reflector 10, the first lens group 20, the second lens group 30, and the third lens group 40 sequentially arrange along the optical axis O from the object-side to the image-side. Light rays enter the optical lens 100 along the optical axis O, being diverted by the reflector 10, and enter the first lens group 20 composed of the first lens L1, the second lens L2, and the third lens L3, the second lens group 30 composed of the fourth lens L4, the fifth lens L5, the sixth lens L6, the seventh lens L7, and the eighth lens L8, and the third lens group 40 composed of the ninth lens L9, the tenth lens L10, the eleventh lens L11 and the twelfth lens L12 in sequence, and finally reach the imaging surface 101.

Specifically, taking the maximum field of view angle FOV3°5′ in the optical lens 100 as an example, other parameters of the optical lens 100 are given in Table 5 below. And the definitions of each of these parameters can be derived from the description of the foregoing embodiment, which will not be elaborated here. In addition, for the correspondence between the refractive power and the shape of each lens, please refer to the foregoing Embodiment 4, which will not be elaborated here.

TABLE 5
Embodiment 5
FOV = 3°5′

| | | Thick- | Refractive | Abbe | Optical |
|---|---|---|---|---|---|
| Lens | Y Radius | ness | index | number | power |
| First lens L1 | 21.630 | 6.559 | 1.73 | 28.30 | Negative |
| | 11.932 | | | | |
| Second lens L2 | 12.157 | 2.151 | 1.61 | 37.00 | Positive |
| | 21.194 | | | | |
| Third lensL3 | 48.021 | 7.439 | 1.61 | 37.00 | Positive |
| | 95.553 | | | | |
| Fourth lens L4 | 142.535 | 8.000 | 1.62 | 36.40 | Negative |
| | 27.412 | | | | |
| Fifth lens L5 | 11.834 | 5.961 | 1.92 | 18.90 | Negative |
| | 6.185 | | | | |
| Sixth lens L6 | 6.317 | 3.063 | 1.62 | 36.40 | Positive |
| | 21.501 | | | | |
| Seventh lens L7 | −39.668 | 4.129 | 1.62 | 36.40 | Negative |
| | −24.888 | | | | |
| Eighth lens L8 | −31.415 | 7.056 | 1.61 | 37.00 | Negative |
| | −201.693 | | | | |
| Ninth lens L9 | 47.772 | 7.744 | 1.62 | 36.40 | Positive |
| | 99.332 | | | | |
| Tenth lens L10 | 19.845 | 7.726 | 1.62 | 36.40 | Positive |
| | 38.668 | | | | |
| Eleventh lens L11 | 147.904 | 2.022 | 1.62 | 36.40 | Positive |
| | 150.023 | | | | |
| Twelfth L12 | −11.082 | 2.000 | 1.62 | 36.40 | Negative |
| | −12.488 | | | | |

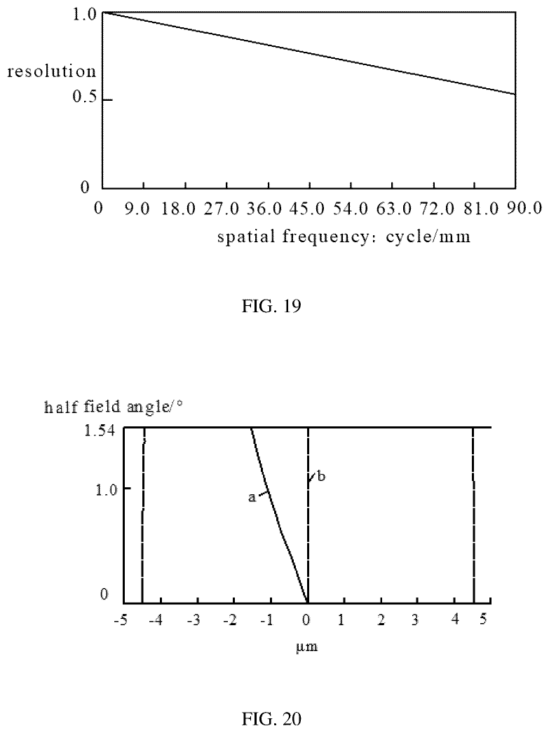

Referring to FIGS. 18 to 20, the field curvature, distortion and chromatic aberration of the optical lens optical lens 100 are well controlled and the optical lens optical lens 100 has good resolution, so that the optical lens optical lens 100 in this embodiment has a good imaging quality. With respect to the wavelengths and labels of the curves in FIGS. 10 to 12, description of FIGS. 2 to 4 in Embodiment 1 may be referred to, which will not be elaborated here.

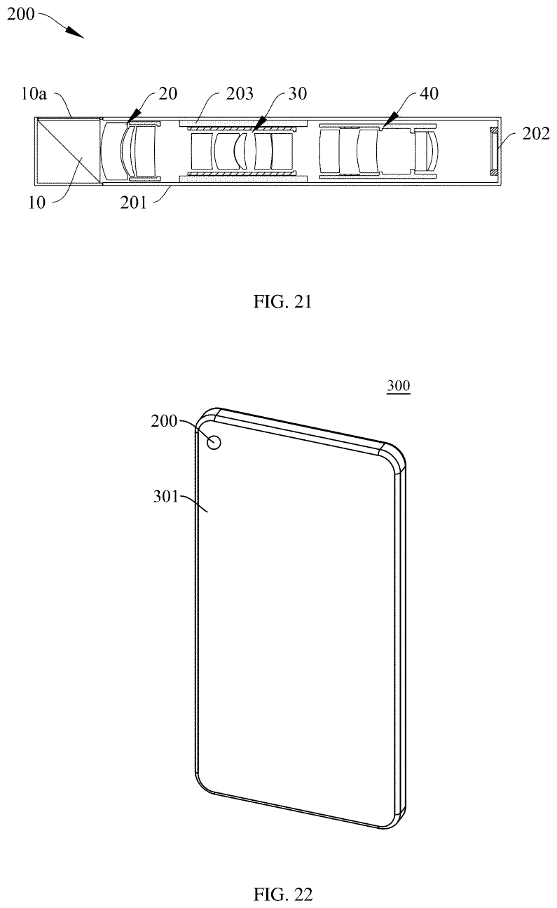

Referring to FIG. 21, the present disclosure also discloses a camera module 200 including a housing 201, an image sensor 202, and the optical lens 100 as in any one of the aforementioned Embodiment 1 to Embodiment 7, the image sensor 202, and the optical lens 100 being both provided in the housing 201, and the image sensor 202 being provided on the image-side of the optical lens 100. Specifically, a sensor surface of the image sensor 202 is provided on the image surface 101 of the optical lens 100, and light rays of an object incident on the sensor surface through the lens may be converted into an electrical signal of the image. The image sensor 202 may be a complementary metal oxide semiconductor (CMOS) or a charge coupled device (CCD). The camera module 200 may be an imaging module integrated on the electronic apparatus 300 or may be an individual lens. It can be understood that the camera module 200 with the aforementioned optical lens 100 has all the technical effects of the aforementioned optical lens 100, i.e., it is made that the camera module 200 enables compact designs of the optical lens 100 and the camera module 200 thereof while being able to meeting the requirements of telephotograph, so that they can be installed into a mobile phone, a tablet, a drone or other electronic apparatus 300. Since the aforementioned technical effects have been described in detail in the embodiments of the optical lens 100, it will not be elaborated here.

In some possible implementation methods, the length of the housing 201 may ranges from 60 mm to 180 mm, and may be, for example, 80 mm, 100 mm, 120 mm, 140 mm or the like. By the length of the housing 201 in the camera module 200 being limited within a reasonable range, the overall length of the camera module 200 may not be too large and the requirements of miniaturization are met, while a plurality of lens groups of the optical lens 100 can be made to have sufficient design space.

In some possible implementation methods, the width of the housing 201 ranges from 15 mm to 60 mm, and may be, for example, 20 mm, 30 mm, 40 mm, 50 mm or the like. By limiting the width of the housing 201 of the camera module 200 within a reasonable range, it is more conducive to the assembly requirements of a plurality of lenses of the optical lens 100.

In some possible implementation methods, the thickness of the housing 201 ranges from 10 mm to 20 mm, and may be, for example, 12 mm, 14 mm, 16 mm, 18 mm or the like. By limiting the thickness of the camera module 200 within a reasonable range, it can be made that the camera module 200 will not occupy too much space in the thickness direction when being installed into the electronic apparatus 300, which is more conducive to the lightness and thinness of the electronic apparatus 300, and at the same time, combining the dimensions of the length and width of the housing 201 being limited within a reasonable range, the camera module 200 is made to have a relatively small overall volume, enabling a feather of miniaturization to the camera module 200 in terms of appearance.

In some possible implementation methods, the weight of the camera module 200 is less than 150 g, and may be, for example, 100 g, 120 g, 130 g, 140 g and so on. By limiting the weight of the camera module 200 within a reasonable range on the weight characteristics, the camera module 200 can be made to weigh not too heavy, which is more conducive to enable the miniaturization and the lightweighting of the camera module 200.

In order to facilitating the focusing or zooming performance of the camera module 200, optionally, the camera module 200 may also include a focusing motor 203, the focusing motor 203 being provided in the housing 201, furthermore the focusing motor 203 being provided corresponding to at least one of the first lens group 20, the second lens group 30, and the third lens group 40 of the optical lens 100, and focusing motor 203 being configured to drive the movement of at least one of first lens group 20, the second lens group 30, and the third lens group 40 to facilitate zooming. The focusing motor 203 is added to control the lens group in the camera module 200, and different requirements of shooting can be adapted to by adjusting the focal length of the lens, so that the user are provided with greater flexibility and convenience.

Exemplarily, the focusing motor 203 may be provided corresponding to the second lens group 30 for driving the movement of the second lens group 30 to facilitate zooming. Specifically, the electromagnetic force generated by the energized coil inside the focusing motor 203 under the action of the magnetic field drives the second lens group 30 to freely telescope to facilitate auto-focusing and clear imaging.

Optionally, the focus motor 203 may include an anti-shaking component, which can sense the direction and amplitude of the shaking of the camera module 200 by means of a gyroscope, and this data is then transmitted to the processor by the sensor, the amount of movement that can counteract the shaking is calculated, and finally a corresponding amount of compensation is made, so that the purpose of optical anti-shake is achieved.

The present disclosure discloses an electronic apparatus 300, the electronic apparatus 300 including an enclosure 301 and the aforementioned camera module 200, the camera module 200 being provided in the enclosure 301. Wherein the electronic apparatus 300 may include, but is not limited to, a mobile phone, a tablet, a laptop computer, a drone, an in-vehicle visualization and monitoring system and so on. Referring to FIG. 22, taking the electronic apparatus 300 as a mobile phone as an example, at this time, the enclosure 301 may be a mobile phone enclosure 301, and the camera module 200 may be provided in the mobile phone enclosure 301.

It could be understood that the electronic apparatus 300 having the aforementioned camera module 200 also has all the technical effects of the aforementioned optical lens 100. That is, the electronic apparatus 300 can be made to meet the requirements of telephotograph and obtain high-quality photos or videos. Since the aforementioned technical effects have been described in detail in the embodiments of the optical lens 100, they will not be elaborated here.

The optical lens, the camera module and the electronic apparatus disclosed in the embodiments of the present disclosure are described in detail above, in this specification, specific examples are applied to interpret the principle and implementation of the present disclosure, and the above embodiments are only used to help understand the optical lens, the camera module and the electronic apparatus of the present disclosure and core idea thereof; at the same time, to those skilled in the art, based on the idea of the present disclosure, specific implementation and disclosure scope may be changed, in summary, the contents of this specification should not be interpreted as a limitation of the present disclosure.

What is claimed is:

1. An optical lens comprising:
a reflector, a first lens group, a second lens group, and a third lens group sequentially arranged along an optical axis from an object-side to an image-side, the reflector, configured to reflect incident light rays so that the incident light rays exit in a direction of the optical axis, the first lens group, comprising a first lens, a second lens, and a third lens sequentially arranged along the optical axis from the object-side to the image-side, the second lens group, comprising a fourth lens, a fifth lens, a sixth lens, a seventh lens, and an eighth lens sequentially arranged along the optical axis from the object-side to the image-side, the third lens group, comprising a ninth lens, a tenth lens, and an eleventh lens sequentially arranged along the optical axis from the object-side to the image-side;
the first lens has negative refractive power, the first lens has a convex object-side surface in a paraxial region, and the first lens has a concave image-side surface in a paraxial region;
the second lens has positive refractive power, the second lens has a convex object-side surface in a paraxial region, and the second lens has a concave image-side surface in a paraxial region;
the third lens has positive refractive power, the third lens has a convex object-side surface in a paraxial region, and the third lens has a concave image-side surface in a paraxial region;
the fourth lens has negative refractive power, the fourth lens has a convex object-side surface in a paraxial region, and the fourth lens has a concave image-side surface in a paraxial region;
the fifth lens has negative refractive power, the fifth lens has a convex object-side surface in a paraxial region, and the fifth lens has a concave image-side surface in a paraxial region;
the sixth lens has positive refractive power, the sixth lens has a convex object-side surface in a paraxial region, and the sixth lens has a concave image-side surface in a paraxial region;
the seventh lens has negative refractive power, the seventh lens has a concave object-side surface in a paraxial region, and the seventh lens has a convex image-side surface in a paraxial region;
the eighth lens has negative refractive power, the eighth lens has a concave object-side surface in a paraxial region, and the eighth lens has a convex image-side surface in a paraxial region;
the ninth lens has positive refractive power, the ninth lens has a convex object-side surface in a paraxial region, and the ninth lens has a concave image-side surface in a paraxial region;
the tenth lens has positive refractive power, the tenth lens has a convex object-side surface in a paraxial region, and the tenth lens has a concave image-side surface in a paraxial region;
the eleventh lens has refractive power,
the optical lens satisfies the relationships:
FOV<12° and/or F>200 mm, 60 mm<L<120 mm, and a maximum outer diameter of any lens from the first lens to the eleventh lens is less than 40 mm;
wherein FOV is a field of view angle of the optical lens, L is a maximum path of light rays entering the optical lens from a light inlet to an imaging surface through the reflector, the first lens group, the second lens group, and the third lens group in sequence, and F is a focal length of the optical lens.

2. An optical lens comprising:
a reflector, a first lens group, a second lens group, and a third lens group sequentially arranged along an optical axis from an object-side to an image-side, the reflector, configured to reflect incident light rays so that the incident light rays exit in a direction of the optical axis, the first lens group, comprising a first lens, a second lens, and a third lens sequentially arranged along the optical axis from the object-side to the image-side, the second lens group, comprising a fourth lens, a fifth lens, a sixth lens, a seventh lens, and an eighth lens sequentially arranged along the optical axis from the object-side to the image-side, the third lens group, comprising a ninth lens, a tenth lens, an eleventh lens and a twelfth lens sequentially arranged along the optical axis from the object-side to the image-side;
the first lens has negative refractive power, the first lens has a convex object-side surface in a paraxial region, and the first lens has a concave image-side surface in a paraxial region;
the second lens has positive refractive power, the second lens has a convex object-side surface in a paraxial region, and the second lens has a concave image-side surface in a paraxial region;
the third lens has positive refractive power, the third lens has a convex object-side surface in a paraxial region, and the third lens has a concave image-side surface in a paraxial region;
the fourth lens has negative refractive power, the fourth lens has a convex object-side surface in a paraxial region, and the fourth lens has a concave image-side surface in a paraxial region;
the fifth lens has negative refractive power, the fifth lens has a convex object-side surface in a paraxial region, and the fifth lens has a concave image-side surface in a paraxial region;
the sixth lens has positive refractive power, the sixth lens has a convex object-side surface in a paraxial region, and the sixth lens has a concave image-side surface in a paraxial region;
the seventh lens has negative refractive power, the seventh lens has a concave object-side surface in a paraxial region, and the seventh lens has a convex image-side surface in a paraxial region;
the eighth lens has negative refractive power, the eighth lens has a concave object-side surface in a paraxial region, and the eighth lens has a convex image-side surface in a paraxial region;
the ninth lens has positive refractive power, the ninth lens has a convex object-side surface in a paraxial region, and the ninth lens has a concave image-side surface in a paraxial region;
the tenth lens has positive refractive power, the tenth lens has a convex object-side surface in a paraxial region, and the tenth lens has a concave image-side surface in a paraxial region;
the eleventh lens has refractive power;
the twelfth lens has negative refractive power, the twelfth lens has a concave object-side surface in a paraxial region, and the twelfth lens has a convex image-side surface in a paraxial region;
the optical lens satisfies the relationships:
FOV<12° and/or F>200 mm, 60 mm<L<120 mm, and a maximum outer diameter of any lens from the first lens to the twelfth lens is less than 40 mm;
wherein FOV is a field of view angle of the optical lens, L is a maximum path of light rays entering the optical lens from a light inlet to an imaging surface through the reflector, the first lens group, the second lens group, and the third lens group in sequence, and F is a focal length of the optical lens.

3. The optical lens according to claim 1, wherein the optical lens satisfies the relationships:
$$FOV \leq 8 {°15}^{′} , and / or F \geq 300 mm ;$$
wherein FOV is a field of view angle of the optical lens, and F is a focal length of the optical lens.

4. The optical lens according to claim 2, wherein the optical lens satisfies the relationships:
$$FOV \leq 8 {°15}^{′} , and / or F \geq 300 mm ;$$
wherein FOV is a field of view angle of the optical lens, and F is a focal length of the optical lens.

5. The optical lens according to claim 1, wherein the optical lens satisfies the relationship:
$$FNO > 5.6 ,$$
wherein FNO is an aperture number of the optical lens.

6. The optical lens according to claim 2, wherein the optical lens satisfies the relationship:
$$FNO > 5.6 ,$$
wherein FNO is an aperture number of the optical lens.

7. The optical lens according to claim 1, wherein the eleventh lens has negative refractive power, the eleventh lens has a concave object-side surface in a paraxial region, and the eleventh lens has a convex image-side surface in a paraxial region; or
the eleventh lens has positive refractive power, the eleventh lens has a convex object-side surface in a paraxial region, and the eleventh lens has a concave image-side surface in a paraxial region.

8. The optical lens according to claim 2, wherein the eleventh lens has negative refractive power, the eleventh lens has a concave object-side surface in a paraxial region, and the eleventh lens has a convex image-side surface in a paraxial region; or
the eleventh lens has positive refractive power, the eleventh lens has a convex object-side surface in a paraxial region, and the eleventh lens has a concave image-side surface in a paraxial region.

9. The optical lens according to claim 1, wherein at least one of the first lens group, the second lens group, and the third lens group is movable along the optical axis.

10. The optical lens according to claim 2, wherein at least one of the first lens group, the second lens group, and the third lens group is movable along the optical axis.

11. A camera module comprising:
a housing, an image sensor, and an optical lens according to claim 1; wherein the image sensor and the optical lens are both provided in the housing, and the image sensor is provided at an image-side of the optical lens.

12. The camera module according to claim 11, wherein a length of the housing ranges from 60 mm to 180 mm; and/or a width of the housing ranges from 15 mm to 60 mm; and/or a thickness of the housing ranges from 10 mm to 20 mm; and/or a weight of the camera module is less than 150 g.

13. The camera module according to claim 11, wherein the camera module further comprises a focusing motor provided in the housing and provided corresponding to at least one of the first lens group, the second lens group, and the third lens group of the optical lens; the focusing motor is configured to drive movement of at least one of first lens group, the second lens group, and the third lens group to facilitate zooming.

14. An electronic apparatus comprising an enclosure and a camera module according to claim 11, wherein the imaging module is provided in the enclosure.
